(19) United States
(12) Patent Application Publication
(10) Pub. No.: US 2007/0127701 A1
(43) Pub. Date: Jun. 7, 2007

(54) Exchange system and method of controlling the same

(76) Inventor: Katsushi Edo, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/586,547

(22) Filed: Oct. 26, 2006

(30) Foreign Application Priority Data
Oct. 27, 2005 (JP) 2005-313300

(51) Int. Cl. H04M 1/00; H04M 3/00

(52) U.S. Cl. 379/355.01

(57) ABSTRACT

According to one embodiment, an exchange system includes storage means for storing, as abbreviated dial numbers, connection destination telephone numbers associated with a sender ID of a terminal accessing the exchange system through a public line, and a central control unit which connects the terminal to one of the connection destination telephone numbers corresponding to an abbreviated dial number input by the terminal, when the terminal corresponding to the stored sender ID accesses the exchange system and input the abbreviated dial number.

### CROSS-REFERENCE TO RELATED APPLICATIONS

This application is based upon and claims the benefit of priority from Japanese Patent Application No. 2005-313300, filed Oct. 27, 2005, the entire contents of which are incorporated herein by reference.

### BACKGROUND

1. Field

One embodiment of the present invention relates to an exchange system and a method of controlling the same, which select one of telephone numbers of connection destinations registered in association with a terminal which is registered in advance, when the terminal accesses the exchange system through a public line.

2. Description of the Related Art

Jpn. Pat. Appln. KOKAI Pub. No. 10-65808 discloses a technique wherein, when a predetermined terminal accesses an exchange through a public line, a central office line call connection device of the exchange automatically connects the terminal to a preregistered extension number corresponding to terminal telephone number information being a caller ID of the terminal.

However, the above technique can only connect one terminal that has accessed to one connection destination. Further, the above technique may allow a malicious third party to make a telephone call by using the private branch exchange.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a configuration of an exchange system according to an embodiment of the present invention.

FIG. 2 is a block diagram illustrating a detailed configuration of the exchange system according to the embodiment of the present invention.

FIG. 3 is a flowchart illustrating a control method, to which the exchange system of the present invention is applied.

FIG. 4 is a schematic diagram of table information.

FIG. 5 is a flowchart illustrating a(the?) control method using abbreviated dialing from an external terminal through a public line, by using the table information.

### DETAILED DESCRIPTION

Various embodiments according to the invention will be described hereinafter with reference to the accompanying drawings. In general, according to one embodiment of the invention, an embodiment of the present invention, an exchange system comprises: storage unit for storing, as abbreviated dial numbers, a plurality of connection destination telephone numbers associated with an identification number of a terminal accessing the exchange system through a public line; control unit for allowing input of one of the abbreviated dial numbers from the terminal corresponding to the identification number stored in the storage unit, when the terminal accesses the control unit; and connection unit for connecting the terminal to one of the connection destination telephone numbers corresponding to the input abbreviated dial number, when the terminal inputs one of the abbreviated dial numbers.

An embodiment of the present invention is explained below with reference to the drawings.

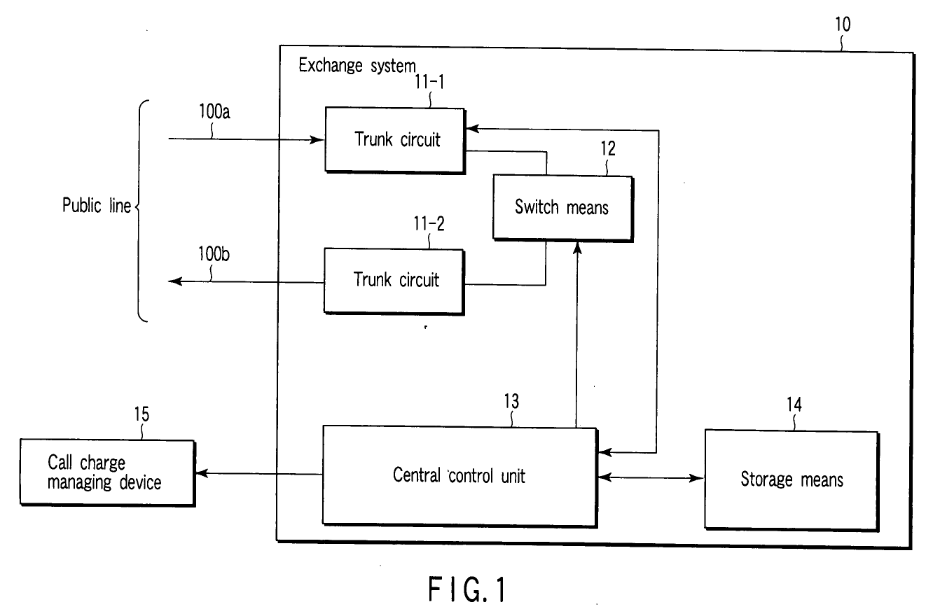

FIG. 1 is a block diagram illustrating a configuration of an exchange system according to an embodiment of the present invention.

An exchange system 10 comprises a trunk circuit 11-1, to which a voice signal from a terminal being a transmission source is input through a public line 100a, a trunk circuit 11-2 which transmits a voice signal to a terminal being a transmission destination and connected to a public line 100b, switch means 12 which performs switching of the trunk circuit 11-1 and the trunk circuit 11-2, a central control unit 13 that performs authentication of terminals that have accessed the exchange system and processing of connecting the authenticated terminal to a number being a connecting destination, and storage means 14 that stores identification numbers (telephone numbers) of terminals associated with extension telephones that performs registration, connection destination numbers of each of the extension telephones, and abbreviated numbers of the connection destination numbers. The exchange system 10 transmits a call record at predetermined timing to a call charge managing device 15.

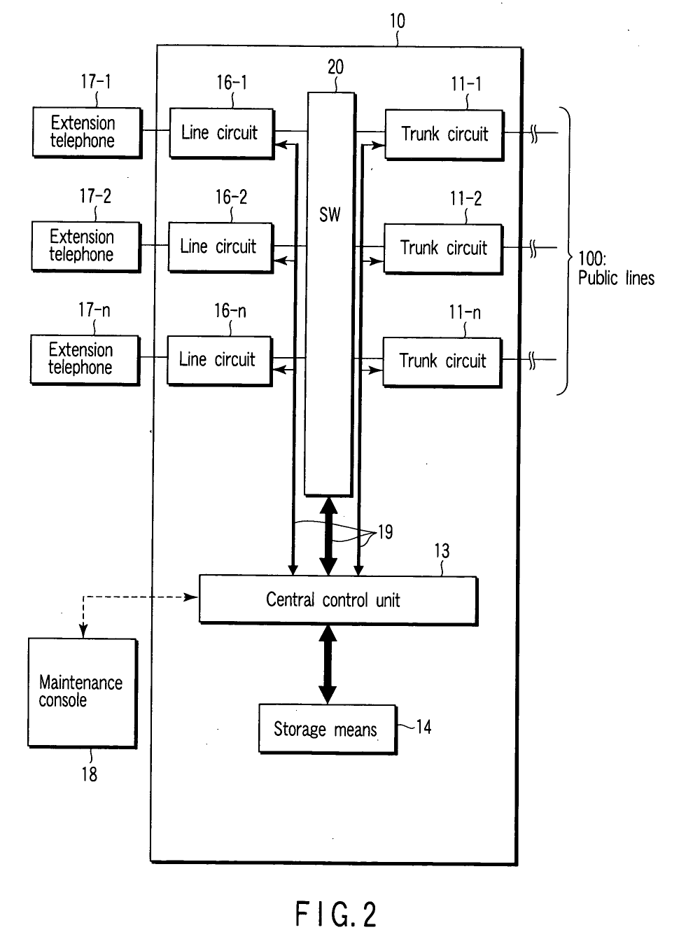

FIG. 2 is a block diagram illustrating a detailed configuration of the exchange system.

The exchange system 10 comprises line circuits 16-1 to 16-n, a call path network (SW) 20, trunk circuits 11-1 to 11-n, the central control unit 13, and the storage means 14.

Extension telephones 17-1 to 17-n are connected to the call path network 20 through the line circuits 16-1 to 16-n in the exchange system 10. The call path network 20 is connected to public lines 100 through the trunk circuits 11-1 to 11-n. The public lines 100 are central office lines.

Further, the call path network 20, the line circuits 16-1 to 16-n and the trunk circuits 11-1 to 11-n are connected to the central control unit 13 through control data bus lines 19. The central control unit 13 performs transmission and reception of necessary data with the storage means 14, the call path network 20, the line circuits 16-1 to 16-n, and the trunk circuits 11-1 to 11-n, and controls exchange of the exchange system 10.

Further, the central control unit 13 forms a call path between the extension telephones 17-1 to 17-n, between one of the extension telephones 17-1 to 17-n and one of the public lines 100, or between two of the public lines 100, through exchange control of the call path network 20 by the central control unit 13.

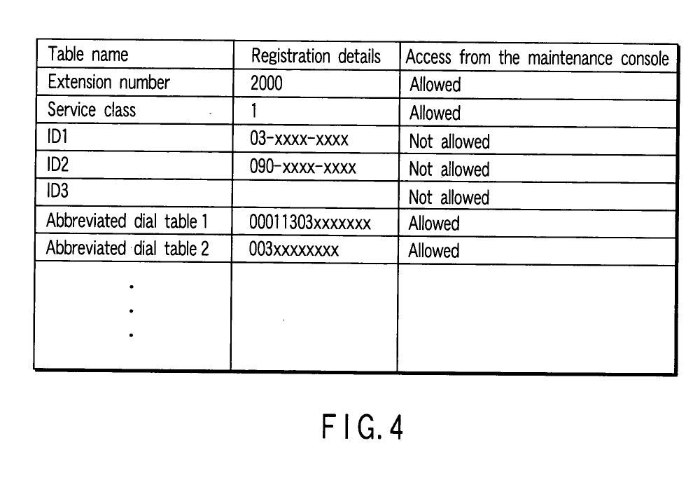

A maintenance console 18 may be provided if necessary. In this case, information concerning an access right from the maintenance console 18 is set as table information (explained later: see FIG. 4).

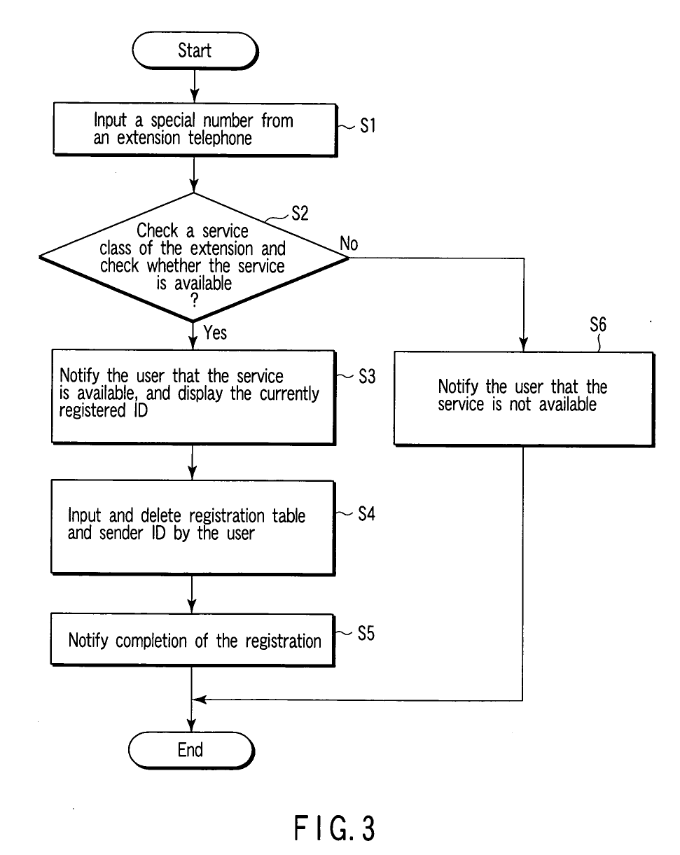

Next, a controlling method applied to the exchange system of the present invention is explained with reference to the flowchart of FIG. 3.

The extension telephone used for registration has a display device for checking the registered information.

First, a special number (for example, “11”) only for registration (and/or deletion) is dialed from a predetermined extension telephone (for example, having a telephone number of 2000) in the extension telephones 17-1 to 17-n connected to the exchange system 10 (step S1).

The storage means 14 of the exchange system 10 registers in advance information items, such as extension numbers, service class (access right), and accessibility from the maintenance console, in the table information items shown in FIG. 4. The central control unit 13 checks a service class corresponding to the extension number of the extension telephone by which the special number is dialed, and checks whether the service is available (step S2). For example, if an extension telephone has an extension number of 2000 and the corresponding service class 1 is available (YES of step S2), an ID of the extension telephone, such as the extension number of the extension telephone is displayed on a display device (such as a liquid crystal display) (step S3).

The extension telephone is operated to register a sender ID (for example, a fixed telephone number of the user's home as ID1) being a telephone number of a terminal of the outside line (public line 100) to be registered (step S4). Further, for example, a telephone number of the user's mobile phone is registered as ID2. It is also possible to delete and change the registered information items. The processing is performed in line with a menu and the like displayed on the display device of the extension telephone. It is possible to prevent access of the maintenance console to he information of the sender IDs of the outside terminals to prevent undesired change of the information by unauthenticated access from the outside.

Further, in the same manner, an abbreviated dial table is registered. It is desirable to register telephone numbers of parties to which the user usually makes a phone call by the extension telephone in the company and the like.

After the above registration, a display indicating completion of the registration is made on the display device of the extension telephone (step S5). Completion of the registration may be notified by sound or an LED light.

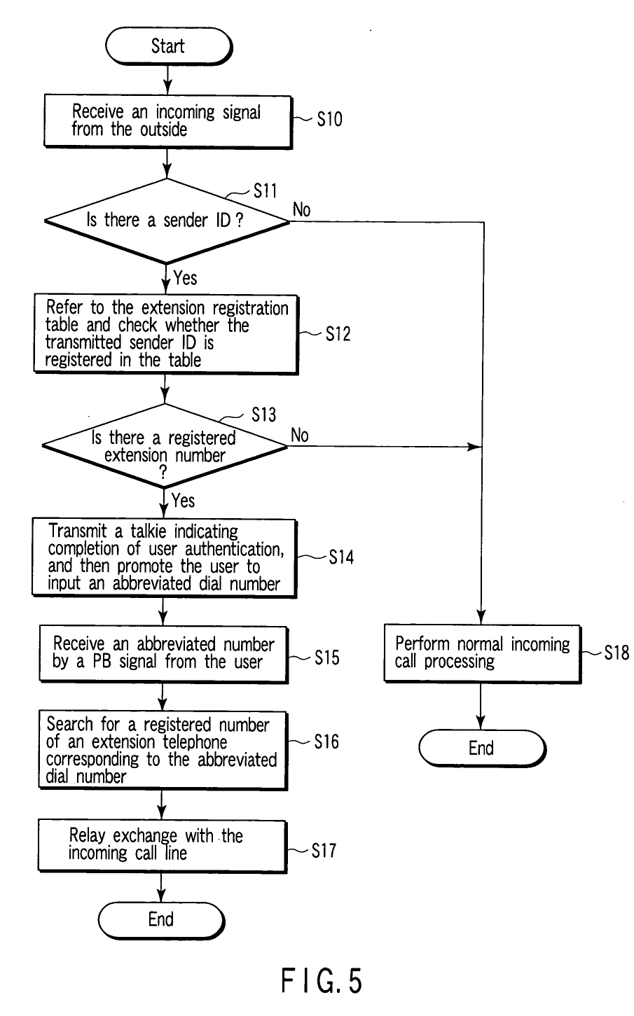

A control method using an abbreviated dial from an outside terminal through the public lines 100 by using the table information items registered as described above is explained with reference to a flowchart of FIG. 5.

When the exchange system 10 receives an incoming signal from the outside through the public line 100 (step S10), the exchange system 10 determines whether the incoming signal has a sender ID (whether a number notification is performed) (step S11). If it is determined that the incoming signal has a sender ID (YES of step S11), the exchange system 10 refers to the above table information, and checks whether the transmitted sender ID exists in the table information (step S12).

If an extension number of an extension telephone corresponding to the sender ID of the calling terminal is registered in the table information (YES of step S13), the exchange system 10 transmits a talkie indicating completion of user authentication to the calling terminal (or a sign may be displayed on the display device of the extension telephone), and prompts the user to input an abbreviated dial number (step S14).

When the exchange system 10 receives an abbreviated dial number by a PB (push button signal) from the terminal (step S15), the exchange system 10 searches the table information stored in the storage means 14 for a telephone number of a connection destination corresponding to the abbreviated dial number (step S16).

If the exchange system 10 finds by the search a telephone number of a connection destination corresponding to the abbreviated dial number, the exchange system 10 performs relay exchange with an incoming call line of the terminal, and connects the calling terminal to the telephone number of the connection destination (step S17).

After the call is ended, the central control unit 13 transmits the sender ID, the extension telephone number and the destination of the call as a call record to the call charge managing device 15.

If there are a plurality of extension telephone numbers associated with the calling terminal, for example, one of the following can be performed:

(1) disconnect the incoming line;

(2) determine an extension telephone to be connected, in accordance with a preregistered priority;

(3) provide a voice message or the like to allow the user to select an extension telephone to be connected;

(4) connect the call to an extension telephone having the lowest extension number among the associated telephone numbers;

(5) connect the call to an extension telephone (such as a transit telephone) preset in the exchange system.

The above setting of the system can be changed if desired.

In the embodiment, the extension telephones are used for registering table information. If there is an access from the outside line, the central control unit 13 performs exchange with reference to the table information stored in the storage means 14, and does not use the extension telephones for authentication.

According to the present invention having the above structure, it is possible to authenticate the user accessing an extension telephone from a remote place, by identifying the sender ID. Further, the present invention enables an outside public line to access the abbreviated dial table registered in the extension telephone usually used in-house, and obviates the necessity for the user of the extension telephone to memorize again client's telephone numbers and the like stored the abbreviated dial table. Further, it is possible to monitor private accesses from outside lines, and reduce dial operation through the outside lines to the minimum by using the abbreviated dial table.

Further, it is possible to completely distinguish between official calls and private calls, by transmitting call records to the call charge managing device. Furthermore, since only the extension telephones can register the sender IDs and abbreviated dial numbers, it is possible to prevent telephone calls by a malicious third party through the private branch exchange.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exchange system comprising:
storage unit for storing, as abbreviated dial numbers, a plurality of connection destination telephone numbers associated with an identification number of a terminal accessing the exchange system through a public line;
control unit for allowing input of one of the abbreviated dial numbers from the terminal corresponding to the identification number stored in the storage unit, when the terminal accesses the control unit; and
connection unit for connecting the terminal to one of the connection destination telephone numbers corresponding to the input abbreviated dial number, when the terminal inputs one of the abbreviated dial numbers.

2. An exchange system according to claim 1, wherein
only an extension telephone connected to the exchange system is allowed to perform operation to store the connection destination telephone numbers associated with the identification number of the terminal as the abbreviated dial numbers.

3. An exchange system according to claim 1, wherein
an access right is set for the extension telephone, and information concerning the access right is stored in the storage unit.

4. An exchange system according to claim 3, wherein
the terminal and the connection destination telephone numbers are stored in association with the extension telephone.

5. An exchange system according to claim 4, further comprising:
a plurality of terminals, each of which is the same as the terminal, registered in association with the extension telephone.

6. An exchange system according to claim 5, wherein
when one of the stored terminals accesses the exchange system, said one of the registered terminals is allowed to be connected to the abbreviated numbers stored in association with the extension telephone corresponding to the terminal.

7. An exchange system according to claim 1, wherein the identification number is a telephone number of the terminal.

8. An exchange system according to claim 1, further comprising:
a maintenance console which accesses the information items stored in the storage unit,
wherein an access right from the maintenance console is set and information concerning the access right is stored in the storage unit.

9. A control method of an exchange system including storage unit for storing, as abbreviated dial numbers, a plurality of connection destination telephone numbers associated with an identification number of a terminal accessing the exchange system through a public line, the method comprising:
a determining step of determining whether the terminal corresponds to the identification number stored in the storage unit, when the terminal accesses the exchange system;
a controlling step of promoting the terminal to input one of the abbreviated dial numbers, when it is determined in the determining step that the terminal corresponds to the identification number; and
a connecting step of connecting the terminal to one of the connection destination telephone numbers corresponding to the input abbreviated dial number.

10. A control method according to claim 9, wherein
only an extension terminal connected to the exchange system is allowed to perform operation to store, as abbreviated dial numbers, the connection destination telephone numbers associated with the identification number of the terminal.
